(19) United States
(12) Patent Application Publication
(10) Pub. No.: US 2012/0090602 A1
(43) Pub. Date: Apr. 19, 2012

(54) METHOD AND APPARATUS FOR THE MANUFACTURE OF CARAMEL

(75) Inventors: Huaigang Zhang, Guigang (CN); Feng Wang, Guigang (CN)

(73) Assignees: Guangxi Guiping City Badi Food Co., Ltd., Guiping (CN); Guangxi Badi Food Co., Ltd., Guigang (CN)

(21) Appl. No.: 13/240,924

(22) Filed: Sep. 22, 2011

(30) Foreign Application Priority Data
Oct. 13, 2010 (CN) 201010506917.0

(51) Int. Cl. B01J 19/00; C13K 13/00

(52) U.S. Cl. 127/2; 127/42

(57) ABSTRACT

The present invention relates to a method for the manufacture of caramel, comprising: providing air to the bottom of a closed reaction container that contains a sugar liquid, making the air rise from the bottom and discharge from the top of the reaction container. In the whole process, the oxygen participates in the catalytic reaction and greatly reduces the amount of the other auxiliary agents, and caramel with a low residual amount of the auxiliary agents is rapidly produced. The present invention further provides an apparatus for use in the above manufacture method.

### FIELD OF THE INVENTION

The present invention relates to a process for the manufacture of food additives. In particular, the present invention relates to a method for the manufacture of caramel.

The present invention further relates to an apparatus for carrying out the above method.

### BACKGROUND OF THE INVENTION

Caramel, also referred to as burnt sugar or saccharum ustum, is a widely used natural colorant in food products. It is one of the important members in foods additives.

At present, the production of the caramel comprises two types, i.e. opened reaction and closed reaction. Opened reaction is a reaction by mixing homogeneously in an opened reactor a sugar liquid and catalysts and heating to a certain temperature, with agitating and adding antifoaming agent as required. The reaction velocity of this method is limited because the temperature cannot be too high due to the limitation by the boiling point of the liquid.

Closed reaction is a reaction by mixing homogeneously in a closed reactor a sugar liquid and catalysts and heating to a certain temperature, and maintaining such a temperature until the end of the reaction. In the whole reaction system, there are only the sugar liquid and the auxiliary agents. The coking process is completed solely by the high temperature and the auxiliary agents such as amines and sulfites. This method is easy to control and has a rapid reaction velocity, but the utilization ratio of the catalysts is not high.

### SUMMARY OF THE INVENTION

One of the objectives of the present invention is to provide a method for the manufacture of caramel.

Another objective of the present invention is to provide an apparatus for carrying out the above method.

For this purpose, the present invention provides a method for the manufacture of caramel, comprising: providing air to the bottom of a closed reaction container that contains reaction materials, making the air rise from the bottom and discharge from the top of the reaction container.

In an embodiment of the method, the air is provided continuously during the whole process of the reaction.

The present invention further provides an apparatus for use in the above method, comprising:
an air inlet pipe, one end of the air inlet pipe being positioned at the bottom of the closed reaction container, the other end of the air inlet pipe being connected to an air source;
an air outlet pipe positioned at the top of the reaction container.

In an embodiment of the apparatus, the air inlet pipe is inserted into the bottom of the reaction container from the top of the reaction container.

In an embodiment of the apparatus, the air source is an air compressor.

In an embodiment of the apparatus, the air source is an air reservoir that connected to an air compressor.

In an embodiment of the apparatus, a check valve and an air inlet control switch are disposed on the air inlet pipe.

In an embodiment of the apparatus, an air outlet control switch is disposed on the air out let pipe.

In an embodiment of the apparatus, the other end of the air outlet pipe is connected to an absorption cell.

The present invention can overcome the defects in the prior art of caramel production that a large quantity of auxiliary agents are added and are incompletely utilized.

### BRIEF DESCRIPTION OF THE DRAWINGS

FIG. 1 is a schematic diagram of the present invention.

The symbols for the main components in the figure are indicated as follows:

1: reactor, 2: air inlet pipe, 3: check valve, 4, air inlet control switch, 5, air compressor and air reservoir, 6: air outlet pipe, 7: absorption cell, 8: air outlet control switch.

### DETAILED DESCRIPTION OF THE INVENTION

The present invention provides a method for the manufacture of caramel, comprising: providing air to the bottom of a closed reaction container that contains a sugar liquid via an air compressor, the air then rising from the bottom of the reaction container to the above of the liquid level and discharging from an air outlet pipe located at the top of the reaction container.

In the embodiments of the present invention, the following figure describes part of the mechanism for Maillard reaction involved in the caramel production process. The oxygen catalyzes the enol structures of intermediate products to aldehyde ketone structures via its own catalytic action.

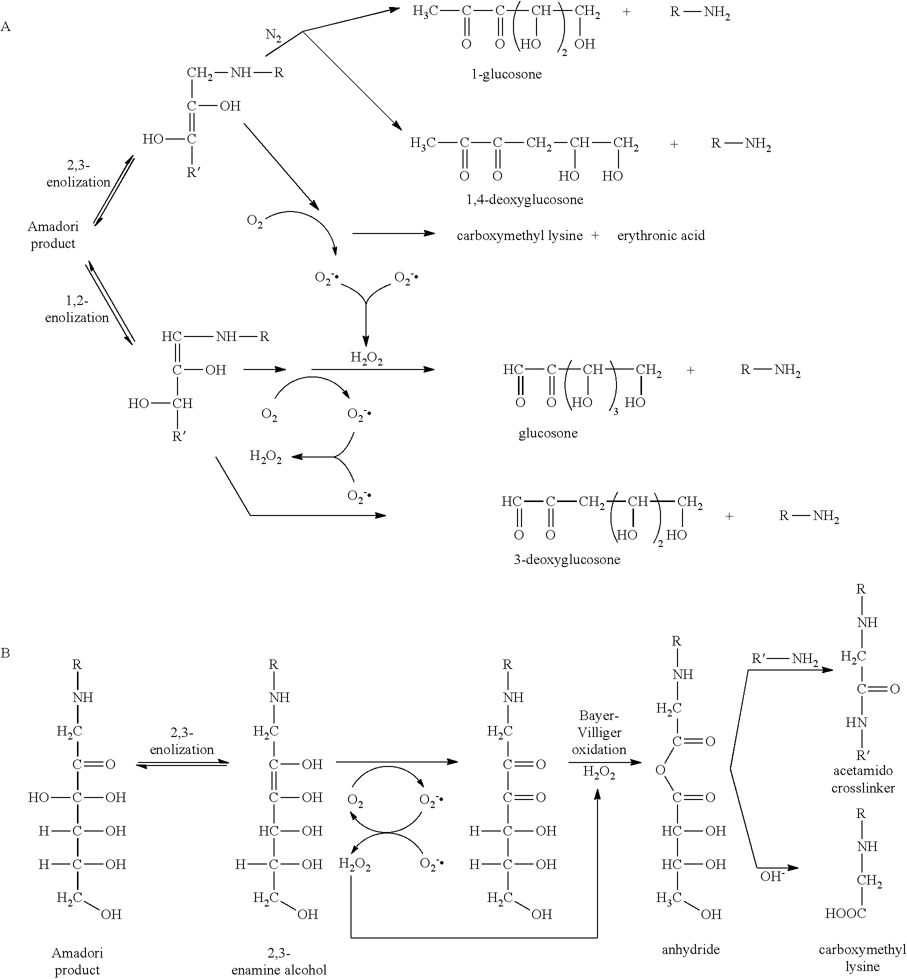

### Part of the Mechanism for Maillard Reaction

In the whole process, the oxygen catalyzes the oxidation of the sugar, and move the balance of the caramel synthesis reaction towards the production of the melanoidins so as to improve the utilization ratio of the sugar in the coking process, and meanwhile the utilization ratio of the auxiliary agent is also improved accordingly, and the residual amount of the auxiliary agent in the final products is also efficiently reduced. At the same time, the existence of the active oxygen in the reaction system is advantageous for the formation of macromolecule free radicals, which are used for the polymerization in the later stage of the Maillard reaction and caramelization reaction, and thus reduces the energy barrier of the polymerization. As a result, the reaction proceeds rapidly and the reaction time is greatly reduced. The production efficiency is thus improved and the caramel with a low residual amount of the auxiliary agent is produced rapidly.

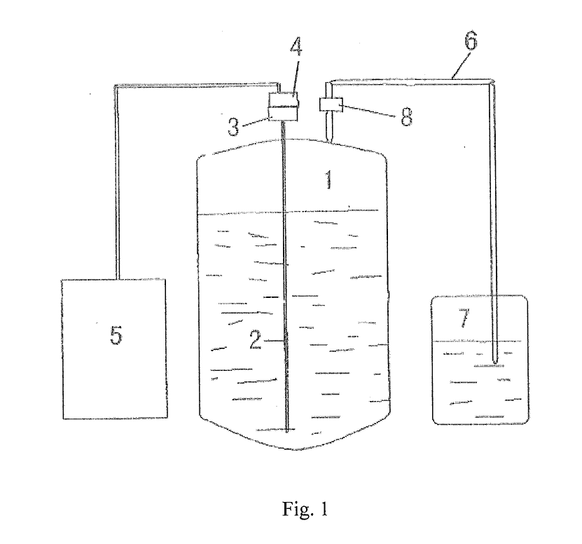

The apparatus used in the present invention (see FIG. 1) comprises a commonly known closed reaction container 1 (with a diameter of 2.5 m and a height of 5.5 m). Said reaction container can be a general reactor. An air inlet pipe 2 is inserted from the top of the reaction container and reaches its bottom. An air reservoir 5 is connected to one end of the air inlet pipe 2 outside the reaction container. The air inlet pipe 2 may also be directly connected to an air compressor which is commonly known in the art (not shown in FIG. 1). An air outlet pipe 6 is disposed on the top of the reaction container 1. The gas in the air reservoir 5 goes through the air inlet pipe 2 into the reaction container 1, and then discharges from the air outlet pipe 6 to the outside of the reaction container 1, and the discharged gas is absorbed by and processed in an absorption cell 7. In order to control the pressure of the incoming gas, an air inlet control switch 4 is disposed on the air inlet pipe 2. Meanwhile, in order to prevent the outflow of the sugar liquid from the air inlet pipe 2 due to an overhigh pressure inside the reaction container, a check valve 3 is disposed on the air inlet pipe 2.

A sugar liquid (liquid glucose, with a solid content of 75% by weight, and a DE (dextrose equivalent) value of 57%, purchased from YANNAN Starch Group Co. Ltd., Hebei province, China) and a processing auxiliary agent (ammonium sulfite, with a purity of 95%, purchased from DANXING YAAN Co. Ltd., Dancheng county, Henan province, China, the added amount of ammonium sulfite depending upon the Spec of the caramel as required) were mixed homogeneously in the reaction container 1. The amount of the sugar liquid was such that the liquid level is as high as 3 m in the reactor. The pH was adjusted to 7.2˜7.5 by using food-grade sodium hydroxide (with a purity of 98%, purchased from Shanghai SHENGWAN Fine Chemicals Co. Ltd.). The air inlet control switch 4, the air outlet control switch 8 and the top lid of the reaction container were closed so as to ensure an airtight condition of the reaction container. Then the sugar liquid was heated to a temperature of 120° C.˜125° C. The air inlet control switch 4, the air outlet control switch 8 and the air compressor were started up. The air in the air reservoir 5 of air compressor was continuously introduced into the bottom of the reaction container through the air inlet pipe 2 (with a gas flow rate of about 3.3 m³/s). The air outlet control switch 8 was controlled so that the gas flowed at the above flow rate into the absorption cell 7 (containing an alkaline liquor of 30% sodium hydroxide) through air outlet pipe 6, and thus the pressure in the reaction container was maintained constantly at 0.2˜0.25 MPa, and the reaction was run until the chromaticness was fixed (see National Standard No. GB 8817-2001 for the measurement of the chromaticness), and then discharged.

TABLE 1
Reaction parameters under different conditions.

| | Dry matter | | Amount of the | | | |
|---|---|---|---|---|---|---|
| | of the sugar | | Auxiliary agent | Reaction | Chromaticness | Residual amount of |
| | liquid | Temperature | added | time (h) | at the end | sulfur dioxide |
| With air | 70% | 120° C.^{~}125° C. | 6% (by the dry | 3.5 | 18947 | 0.03% |
| | | | matter of the | | | |
| | | | sugar liquid) | | | |
| Without air | 70% | 120° C.^{~}125° C. | 6% (by the dry | 5 | 18421 | 0.05% |
| | | | matter of the | | | |
| | | | sugar liquid) | | | |
| With air | 70% | 120° C.^{~}125° C. | 4% (by the dry | 1.2 | 11842 | 0.04% |
| | | | matter of the | | | |
| | | | sugar liquid) | | | |
| Without air | 70% | 120° C.^{~}125° C. | 4% (by the dry | 2.5 | 12105 | 0.07% |
| | | | matter of the | | | |
| | | | sugar liquid) | | | |

Under the same conditions, the introduction of the air reduced the reaction time by 0.3˜1 times, with a lower residual amount of the auxiliary agent (sulfur dioxide). The sulfur dioxide in the final products meets the requirement of National Standard No. 8817-2001.

What is claimed is:

1. A method for the manufacture of caramel, comprising,
providing air to the bottom of a closed reaction container that contains a sugar liquid, making the air rise from the bottom and discharge from the top of the reaction container.

2. The method for the manufacture of caramel according to claim 1, wherein the air is provided continuously during the whole process of the reaction.

3. The method for the manufacture of caramel according to claim 1, wherein the content of the dry matter in the sugar liquid is 70%, and a pH of 7.2˜7.5 and a reaction temperature of 120° C.˜125° C. are used, and a pressure of 0.2˜0.25 MPa in the reaction container is maintained, and an auxiliary agent of an amount of 4%-6% (based on the dry matter in the sugar liquid) is added, and preferably said sugar liquid is glucose liquid and said auxiliary agent is ammonium sulfite.

4. An apparatus for use in the method according to claim 1, comprising:
an air inlet pipe, one end of the air inlet pipe being positioned at the bottom of the closed reaction container, and the other end of the air inlet pipe being connected to an air source;
an air outlet pipe positioned at the top of the reaction container.

5. The apparatus according to claim 4, wherein the air inlet pipe is inserted into the bottom of the reaction container from the top of the reaction container.

6. The apparatus according to claim 4, wherein the air source is an air compressor.

7. The apparatus according to claim 4, wherein the air source is an air reservoir that connected to an air compressor.

8. The apparatus according to claim 4, wherein a check valve and an air inlet control switch are disposed on the air inlet pipe.

9. The apparatus according to claim 4, wherein an air outlet control switch is disposed on the air outlet pipe.

10. The apparatus according to claim 4, wherein the other end of the air outlet pipe is connected to an absorption cell.
